(19) United States
(12) Patent Application Publication
(10) Pub. No.: US 2006/0081563 A1
(43) Pub. Date: Apr. 20, 2006

(54) Resistance welding electrodes, resistance welding methods and welded structures

(75) Inventors: Koji Ueda, Wako-shi (JP); Akira Yanagita, Wako-shi (JP)

Correspondence Address: ARENT FOX PLLC, 1050 CONNECTICUT AVENUE, N.W., SUITE 400, WASHINGTON, DC, 20036, US

(73) Assignee: HONDA MOTOR CO., LTD.

(21) Appl. No.: 11/241,946

(22) Filed: Oct. 4, 2005

(30) Foreign Application Priority Data
Oct. 19, 2004 (JP) 2004-304747

(51) Int. Cl. B23K 11/30

(52) U.S. Cl. 219/119

(57) ABSTRACT

A pair of vertically aligned electrodes for the resistance welding of a plurality of metal sheets. One of the electrodes has a concave end surface and a groove formed therein for distributing a welding current.

### FIELD OF THE INVENTION

The present invention relates to an improvement in spot welding technology.

### BACKGROUND OF THE INVENTION

Various welding processes are in practical use. Spot welding can join thin sheets together quickly and is, therefore, used universally in the manufacture of automobile bodies.

Spot welding is a kind of resistance welding carried out by clamping the metal sheets to be welded between a pair of electrodes, applying an electric current and pressure to the metal sheets to form a molten spot therebetween and solidifying the molten spot to join the metal sheets together.

Spot welding is, however, encountered by a phenomenon characterized by the splash of welding sparks in all directions and resulting in expulsion and surface flashes. This phenomenon is the splash of a part of molten metal which is presumably caused by the loss of a good balance between the expanding action of the metal and the growth of a nugget as a large amount of electric current is concentrated on a very small area in a short period of time to promote melting. Accordingly, a part of inputted electrical energy is wasted and a weld nugget undesirably loses stability in shape.

A spot welding method employing specifically shaped electrodes to prevent expulsion and surface flashes is proposed in, for example, JP-A-11-342477. This method is described with reference to FIG. 21.

Referring to FIG. 21, a steel sheet 103 and an aluminum sheet 104 placed thereon are held together between a pair of vertically spaced apart electrodes 101 and 102, the lower electrode 101 having a convex end, while the upper electrode 102 has a concave end, and a DC power source 105 is connected between the electrodes 101 and 102 to supply an electric current thereto. The concave end of the upper electrode 102 allows a part of the upper aluminum sheet 104 to bulge upwardly, whereby a clearance 106 is formed between the sheets 103 and 104. Expulsion and surface flashes, if any, are confined within the clearance 106.

The welding method as described above is, however, intended for joining sheets having different melting points, such as aluminum and steel, and is not suitable for joining steel sheets together.

The confinement of expulsion and surface flashes within the clearance makes a welded structure look sound. The occurrence of expulsion and surface flashes, however, makes a weld nugget unstable in shape and low in strength. Therefore, there is a demand for resistance welding technology which can prevent any expulsion and surface flash effectively.

### SUMMARY OF THE INVENTION

According to one aspect of this invention, there is provided a resistance welding electrode combination used for welding together a plurality of metal sheets held on each other under pressure as the materials to be welded, the combination comprising a first electrode and a second electrode, wherein one of the first and second electrodes has a concave end surface having a groove formed therein for distributing a welding current.

The distribution of a welding current by the groove formed in the concave end surface of one of the electrodes in the electrode combination according to this invention allows a plurality of molten spots to be formed between the two electrodes and eventually grow into a single weld nugget. Therefore, it is possible to prevent any expulsion and surface flash and thereby achieve a high welding strength.

While it has hitherto been the case with spot welding that a single molten spot is formed between the two electrodes, and that when it grows into a weld nugget, expulsion and surface flashes are formed, no such expulsion or surface flash results from spot welding performed by using the electrodes according to this invention.

The other electrode differing from that having a concave end surface preferably has a convex end surface facing the concave end surface. The convex and concave end surfaces of the electrodes are substantially complementary to each other and define a relatively large area of contact between the materials to be welded. The large area of contact therebetween makes it possible to suppress any excessive concentration of an electric current and thereby prevent any expulsion and surface flash and achieve a high welding strength.

The groove is preferably formed by a set of radial grooves extending through the center of the bottom of the concave end surface. The radial grooves can divide the concave end surface into a plurality of symmetric portions and thereby distribute a welding current still more uniformly.

According to another aspect of this invention, there is provided a resistance welding process comprising the steps of preparing a pair of electrodes consisting of a first electrode having a concave end surface and a second electrode having a convex end surface, a device for applying pressure to urge one of the electrodes toward the other, a device for supplying a welding current to the electrodes and a plurality of metal sheets laid on each other to form the materials to be welded; clamping the materials to be welded between the electrodes to cause the materials to undergo plastic deformation; and supplying a welding current to the electrodes to weld the materials, while maintaining an appropriate pressure between the electrodes.

The welding process is characterized by including the step of causing the materials to be welded to undergo plastic working prior to their welding. The plastic working of the metal sheets enables them to contact each other so closely as not to leave therebetween any clearance otherwise formed between adjoining welding points and is particularly effective for improving the welding strength of a welded structure having a multiplicity of welding points.

The process is also characterized by employing the electrode having a concave end surface as one of the welding electrodes. The concave end surface of the electrode defines a relatively large area of contact between the materials to be welded. The large area of contact provides an enlarged contact area. The large area of contact therebetween makes it possible to suppress any excessive concentration of an electric current and thereby prevent any expulsion and surface flash and achieve a high welding strength.

The first electrode preferably has a set of radial grooves formed in its concave end surface to distribute the welding current. The distribution of the welding current along the grooves is still more effective for preventing any expulsion and surface flash and achieving a high welding strength.

According to a further aspect of this invention, there is provided a welded structure comprising a plurality of metal sheets laid on each other as the materials to be welded, a weld nugget joining the materials together and a bulged portion formed on that portion of the outer surface of one of the materials joined together within which the weld nugget exists.

The bulged portion serves to add to the rigidity of the structure and improve the strength and impact absorbing capacity of the welded joint and its vicinity. The bulged portion preferably has a protrusion formed thereon. The protrusion serves as a reinforcing rib and contributes to improving the strength and impact absorbing capacity of the welded joint and its vicinity to a further extent. Thus, the welded structure having the bulged portion and the protrusion is a member which is higher in strength than any known spot welded structure. The welded structure of this invention is, therefore, small in wall thickness, compact, light in weight and high in rigidity.

### BRIEF DESCRIPTION OF THE DRAWINGS

Certain preferred embodiments of this invention will now be described in detail, by way of example only, with reference to the accompanying drawings, in which:

FIG. 1 is a diagram showing a resistance welding apparatus including electrodes embodying this invention;

FIGS. 2A and 2B are diagrams showing the lower electrode embodying this invention as shown in FIG. 1;

FIG. 3 is an illustration of steps (a) to (e) of a resistance welding process embodying this invention;

FIG. 4 is a perspective view of a welded structure made by the resistance welding process embodying this invention;

FIG. 5 is an illustration of electrodes (a) to (f) as prepared for welding experiments;

FIG. 6 is a perspective view of a test specimen as prepared for a shear strength test;

FIG. 7 is a perspective view of a test specimen and a jig as prepared for a cross strength test;

FIGS. 8A and 8B are diagrams showing the fracture of the nugget on the test specimen shown in FIG. 7;

FIG. 9 is a graph comparing Examples 1 to 5 and Comparative Example 1 in shear strength;

FIG. 10 is a graph comparing Examples 1 to 5 and Comparative Example 1 in cross strength;

FIG. 11 is a graph comparing Examples 6 to 10 and Comparative Example 2 in shear strength;

FIG. 12 is a graph comparing Examples 6 to 10 and Comparative Example 2 in cross strength;

FIGS. 13A to 13C are an illustration of electrodes according to Comparative Example 3 and Example 11;

FIG. 14 is a diagram showing the principle of a method of measuring pressure;

FIG. 15 is a graph showing the pressure as measured;

FIGS. 16A and 16B are diagrams showing the areas of contact as defined between the materials to be welded upon application of pressure thereto by the electrodes according to Comparative Example 3 and Example 11, respectively;

FIGS. 17A and 17B are diagrams comparing the weld nuggets as formed under application of pressure by the electrodes according to Comparative Example 3 and Example 11, respectively;

FIG. 18 is a perspective view of a welded structure as obtained by using the electrodes according to Example 11;

FIG. 19 is a sectional view showing the weld nugget in the structure shown in FIG. 18;

FIGS. 20A and 20B are diagrams showing electrodes according to Example 12; and

FIG. 21 is a diagram showing aluminum and steel sheets as spot welded by using known electrodes.

### DETAILED DESCRIPTION OF THE PREFERRED EMBODIMENTS

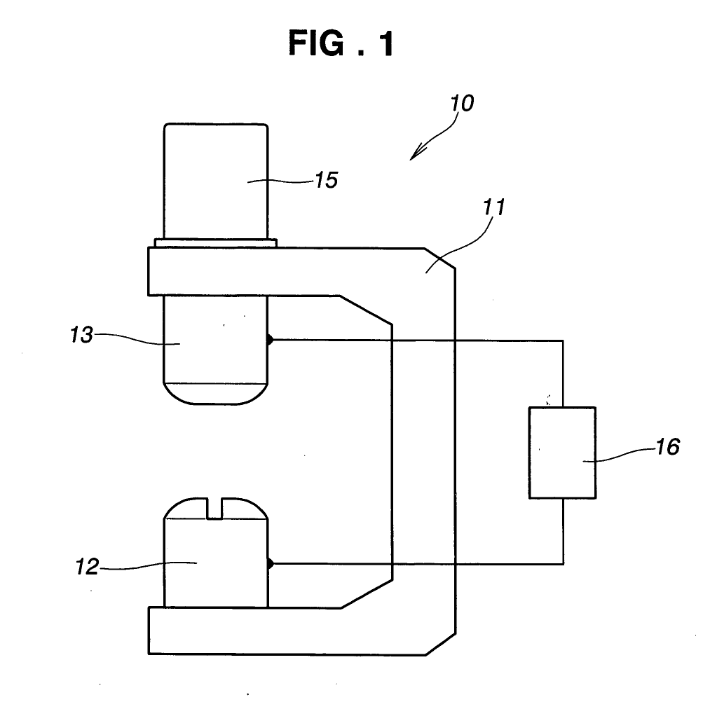

FIG. 1 shows a resistance welding apparatus 10 having a U-shaped frame 11 which can be attached to a robot arm, a first or lower electrode 12 secured to the U-shaped frame 11, a second or upper electrode 13 held by the U-shaped frame 11 vertically movably, a device 15 for applying pressure to the upper electrode 13 to move it toward the lower electrode 12 and a device 16 for supplying an electric current to the electrodes 12 and 13.

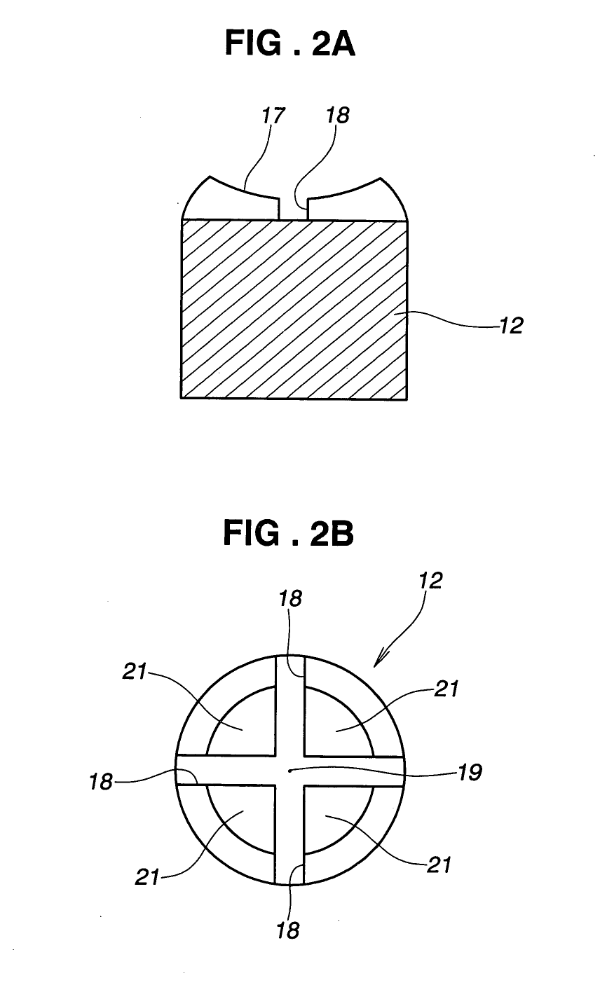

The upper electrode 13 is an ordinary electrode having a convex end surface. On the other hand, the lower electrode 12 is a special electrode having a concave end surface. The shape of the lower electrode 12 will be described with reference to FIGS. 2A and 2B.

The end surface of the lower electrode 12 is a spherically shaped concave surface 17 having a groove 18 formed therein to distribute a welding current, as shown in FIG. 2A. The groove 18 is a cross groove extending through the center 19 of the concave surface 17, as shown in FIG. 2B. The groove 18 divides the concave surface 17 into four arcuate surfaces 21. The groove 18 is a radial groove extending radially outwardly from the center 19 of the concave surface 17. The radial groove extending from the center 19 may be of any desired shape defined by a given number of grooves, such as I, Y, +or *. The groove 18 may be rectangular, U-shaped or V-shaped in cross section, as it is primarily intended for distributing the welding current.

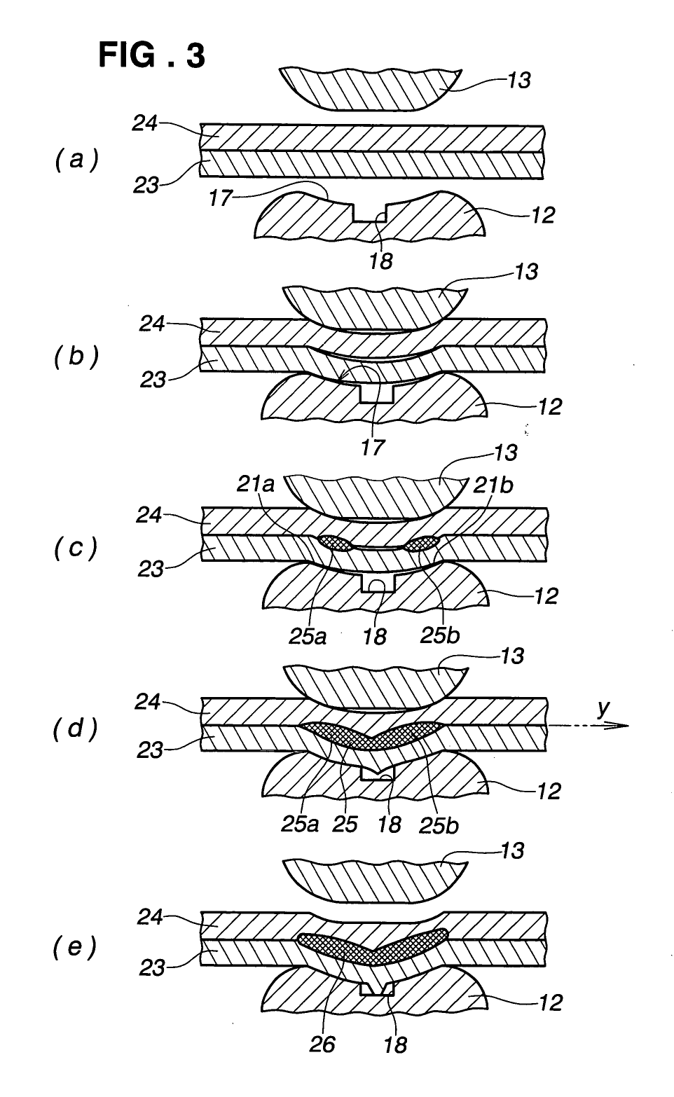

FIG. 3 shows the steps of the resistance welding process embodying this invention at (a) to (e). Two metal sheets 23 and 24 are placed on each other on the lower electrode 12, as shown at (a). The upper electrode 13 is pushed down with a strong force. The metal sheets 23 and 24 are plastically deformed to extend along the concave surface 17, as shown at (b). When an electric current is supplied to the electrodes 12 and 13, its flow is divided into the arcuate surfaces 21 and 21b. As a result, there are formed a plurality of areas 25a and 25b of molten metal (four in the present case). With the continued supply of an electric current, the molten metal areas 25a and 25b grow and combine into a single molten metal area 25, as shown at (d).

The molten metal areas 25a, 25b and 25 are formed when the Joule heat as calculated by multiplying the electrical resistance of the metal sheets by the square of the current has exceeded the melting point of the metal. Accordingly, the molten metal area 25 has a locally high temperature. According to the known spot welding process, therefore, the metal sheets 23 and 24 expanding in proportion to a rise in temperature would act on the molten metal area 25 and elevate its pressure and a part of the molten metal in the area 25 would splash and form expulsion and surface flashes, as shown by an imaginary line and an arrow y.

According to this invention, however, the plastic deformation of the metal sheets between the concave and convex surfaces makes it possible to confine the molten metal having an elevated pressure therebetween and suppress its splash. Moreover, the groove 18 allows the metal sheet 23 to expand thereinto, as shown at (d). The groove 18 provides a space allowing for the expansion of the metal sheet. Thus, the molten metal in the molten metal areas tends to flow into a single mass during the initial stage of current application and the possibility of formation of any area having an undesirably elevated pressure is reduced.

When welding is finished, the upper electrode 13 is raised, as shown at (e). The metal sheet 23 has a portion protruding into the groove 18 between the metal sheets 23 and 24. As a result, the molten metal 25 shown at (d) does not have so high a pressure as to explode, but solidifies into a weld nugget 26.

In summary, the process described above comprises the steps of preparing a pair of electrodes consisting of a first electrode 12 having a concave end surface 17 and a radial groove 18 therein and a second electrode 13 having a convex end surface, a device 15 for applying pressure to relatively urge the first electrode 12 toward the second electrode 13, a device 16 for supplying a welding current to the electrodes 12 and 13 and two metal sheets 23 and 24 laid on each other to form the materials to be welded, as shown in FIGS. 1, 2A, 2B and 3(a); clamping the materials to be welded between the electrodes 12 and 13 to cause the metal sheets 23 and 24 to undergo plastic deformation (see FIG. 3(a) and (b)); and supplying a welding current to the electrodes 12 and 13 to weld the sheets, while maintaining an appropriate pressure between the electrodes (see FIG. 3(c) and (d)), and having the welding current distributed by the groove.

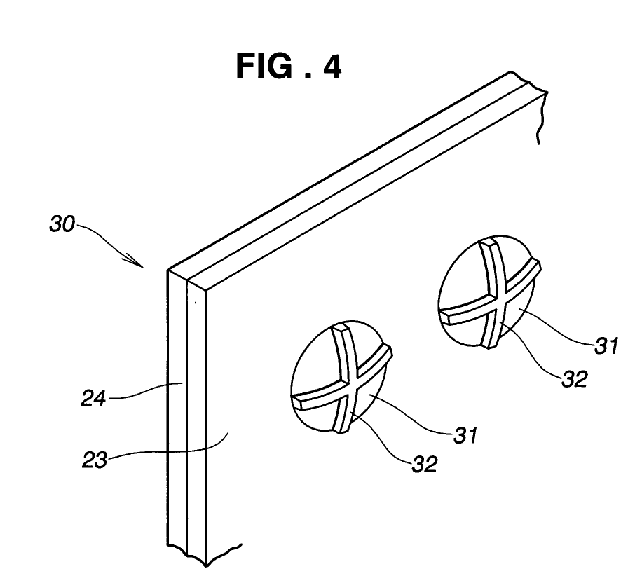

FIG. 4 shows a part of a welded structure 30 made by the resistance welding process according to this invention. The welded structure 30 has bulged portions 31 formed on the outer surface of a metal sheet 23 and a cross-shaped protrusion 32 projecting from each bulged portion 31. More specifically, the welded structure 30 comprises two metal sheets 23 and 24 laid on each other as the materials to be welded, a weld nugget 26 (FIG. 3(e)) joining the materials together and a protrusion 32 formed on that portion of the outer surface of one of the materials joined together within which the weld nugget exists.

When the bending strength of the two metal sheets 23 and 24 is considered, the presence of any rib spaced apart from the center of their bending increases their cross-sectional factor and secondary moment. According to this invention, the cross-shaped protrusion 32 formed in a satisfactorily spaced apart relation from the junction between the two metal sheets 23 and 24 adds to the bending strength, tensile strength and rigidity of the welded joint.

### EXAMPLES OF EXPERIMENTS

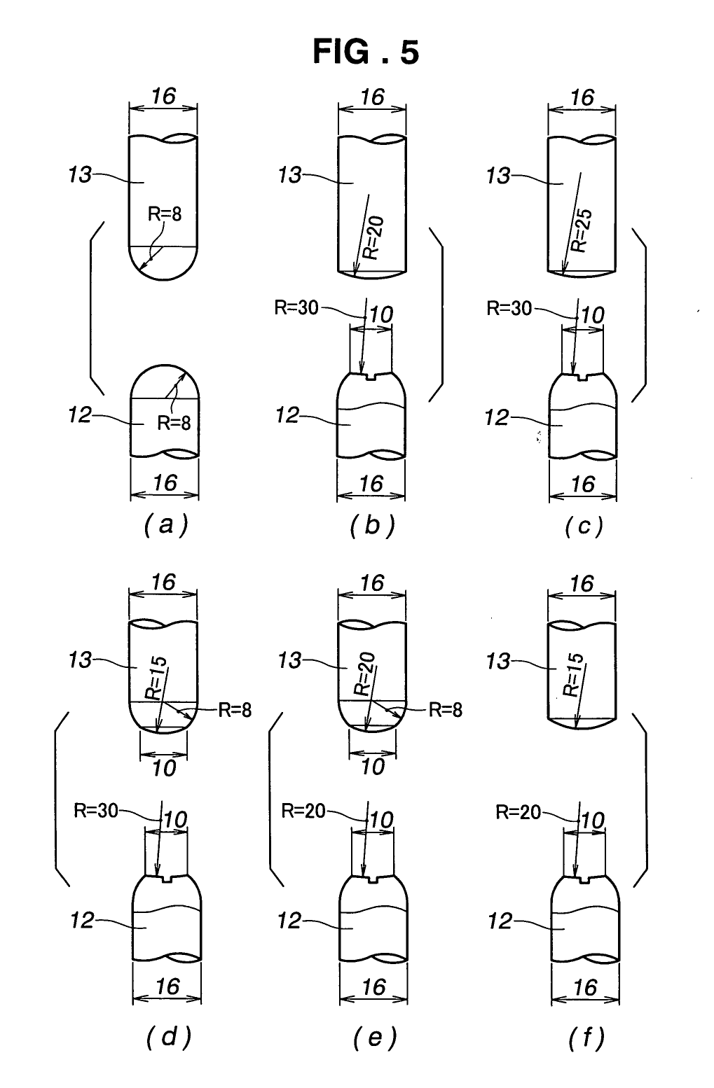

Description will now be made of examples of experiments conducted in connection with this invention. These examples are, however, not intended to limit the scope of this invention. Explanation will first be made of the electrodes used for the experiments with reference to FIG. 5, (a) to (f).

At (a), there are shown an upper electrode 13 formed from a round bar having a diameter of 16 mm and terminating in a semi-spherical lower end having a radius of curvature of 8 mm and a lower electrode 12 formed from a round bar having a diameter of 16 mm and terminating in a semi-spherical upper end having a radius of curvature of 8 mm, which are a pair of ordinary electrodes.

At (b), there is shown an upper electrode 13 formed from a round bar having a diameter of 16 mm and terminating in a spherical lower end surface having a radius of curvature of 20 mm. A lower electrode 12 is formed from a round bar having a diameter of 16 mm and terminating in a spherically shaped concave upper end surface having an edge-to-edge diameter of 10 mm and a radius of curvature of 30 mm and having a cross-shaped groove formed at its bottom.

At (c), there is shown an upper electrode 13 formed from a round bar having a diameter of 16 mm and terminating in a spherical lower end surface having a radius of curvature of 25 mm. A lower electrode 12 is formed from a round bar having a diameter of 16 mm and terminating in a spherically shaped concave upper end surface having an edge-to-edge diameter of 10 mm and a radius of curvature of 30 mm and having a cross-shaped groove formed at its bottom.

At (d), there is shown an upper electrode 13 formed from a round bar having a diameter of 16 mm and terminating in a semi-spherical lower end having a radius of curvature of 8 mm and terminating in a spherical surface having an edge-to-edge diameter of 10 mm and a radius of curvature of 15 mm. Alower electrode 12 is formed from a round bar having a diameter of 16 mm and terminating in a spherically shaped concave upper end surface having an edge-to-edge diameter of 10 mm and a radius of curvature of 30 mm and having a cross-shaped groove formed at its bottom.

At (e), there is shown an upper electrode 13 formed from a round bar having a diameter of 16 mm and terminating in a semi-spherical lower end having a radius of curvature of 8 mm and terminating in a spherical surface having an edge-to-edge diameter of 10 mm and a radius of curvature of 20 mm. A lower electrode 12 is formed from a round bar having a diameter of 16 mm and terminating in a spherically shaped concave upper end surface having an edge-to-edge diameter of 10 mm and a radius of curvature of 20 mm and having a cross-shaped groove formed at its bottom.

At (f), there is shown an upper electrode 13 formed from a round bar having a diameter of 16 mm and terminating in a spherical lower end surface having a radius of curvature of 15 mm. A lower electrode 12 is formed from a round bar having a diameter of 16 mm and terminating in a spherically shaped concave upper end surface having an edge-to-edge diameter of 10 mm and a radius of curvature of 20 mm and having a cross-shaped groove formed at its bottom.

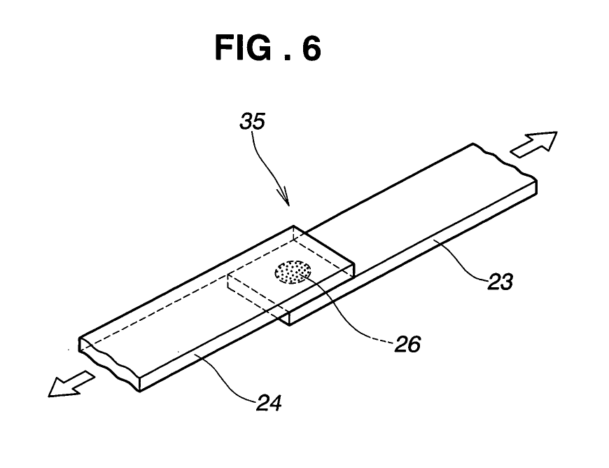

FIG. 6 shows a test specimen 35 used for determining the shear strength of a weld nugget. The test specimen 35 is prepared by joining two 40 mm-wide metal sheets 23 and 24 together with a weld nugget 26 in an overlapping area having a length of 40 mm. It is pulled in the opposite directions as shown by arrows and the force which has caused the shear fracture of the weld nugget 26 is defined as its shear strength. While the shear strength is generally calculated by dividing the force by the cross sectional area, the shearing force is conveniently called the shear strength in the field of spot welding, since it is impossible to determine the cross sectional area of the weld nugget 26 accurately.

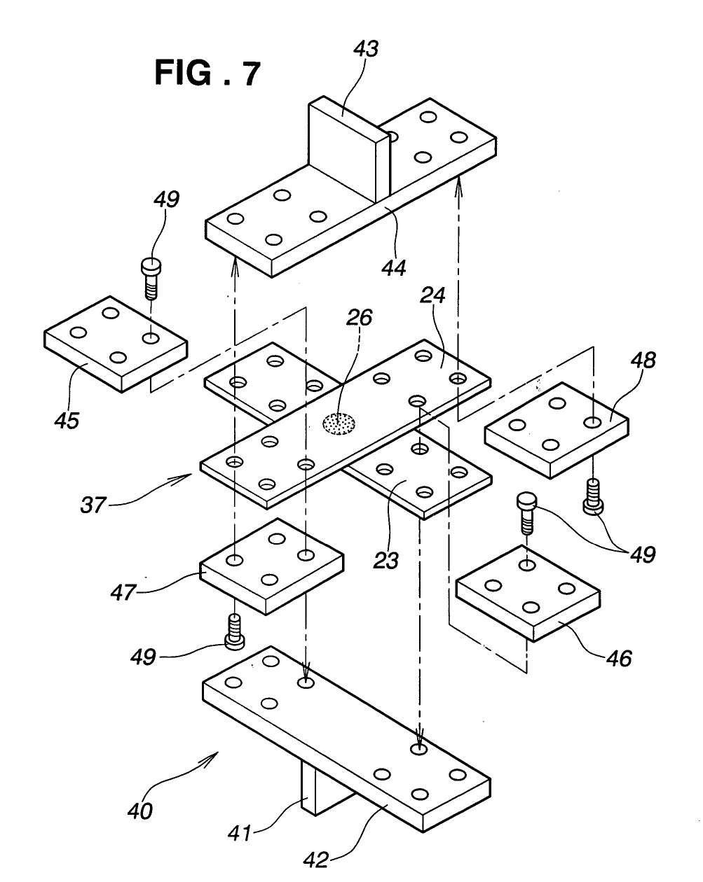

FIG. 7 shows a test specimen 37 and a test jig 40 used for determining the cross strength of a weld nugget. The force causing the fracture of a weld nugget in a cross-shaped test specimen is called its cross strength. The force is called the strength for the reason stated above. The test specimen 37 is prepared by placing two 50 mm-wide metal sheets 23 and 24 in a cross form and joining them together with a weld nugget 26 in their intersecting area.

The test jig 40 includes a 50 mm-wide lower plate 42 having a grip 41, a 50 mm-wide upper plate 44 having a grip 43, four 50 mm-square holding pieces 45 to 48 and a plurality of screws 49. The lower metal sheet 23 of the test specimen 37 is placed on the lower plate 42, and two holding pieces 45 and 46 are placed on the metal sheet 23 and fastened to the lower plate 42 by two screws 49. Then, the upper plate 44 is placed on the metal sheet 24 of the test specimen 37, and the other two holding pieces 47 and 48 are placed on the underside of the metal sheet 24 and fastened to the upper plate 44 by two screws 49.

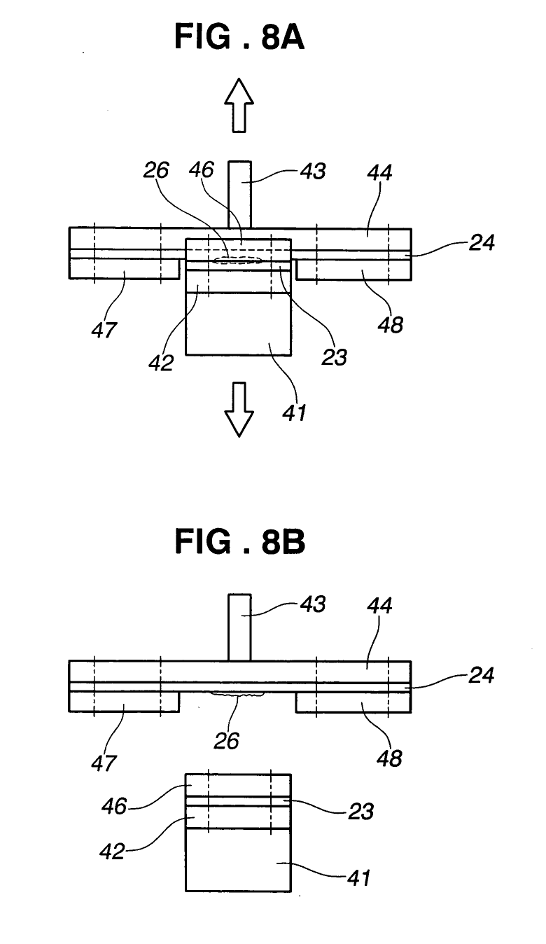

FIGS. 8A and 8B show the fracture of the weld nugget in the test specimen shown in FIG. 7. The grip 41 is pulled down, while the grip 43 is pulled up, as shown in FIG. 8A. An increase in pulling force eventually results in the fracture of the weld nugget 26. FIG. 8B shows the metal sheets 23 and 24 separated from each other as a result of the fracture of the weld nugget 26. As none of the holding pieces 45 to 48 shown in FIG. 7 interferes with the weld nugget 26, it is possible to determine accurately the force which has caused the fracture of the weld nugget 26. As the test specimen is cross-shaped, the force causing the fracture of its weld nugget is called its cross strength. The force is conveniently called the strength for the reason stated before.

A plurality of test specimens for shear and cross strength as shown at 35 and 37 in FIGS. 6 and 7, respectively, were prepared by using the electrodes as described above. The welding conditions and the strength as determined were as stated below.

### Comparative Example 1 and Examples 1 to 5

Sheets of 270N steel having a thickness of 1.6 mm were welded by employing a welding pressure of 400 kgf and a welding current as shown in Table 1. Table 1 shows the type of electrodes as employed by selecting from FIG. 5, the welding current and the shear and cross strength as determined from each test specimen.

TABLE 1

| | Type of | Welding | Shear | Cross |
|---|---|---|---|---|
| | electrodes | current | strength | strength |
| Comparative | FIG. 5 (a) | 11.76 kA | 11.1 kN | 9.9 kN |
| Example 1 | | | | |
| Example 1 | FIG. 5 (b) | 15.45 kA | 13.0 kN | 10.9 kN |
| Example 2 | FIG. 5 (c) | 14.04 kA | 12.5 kN | 10.7 kN |
| Example 3 | FIG. 5 (d) | 14.06 kA | 12.3 kN | 10.1 kN |
| Example 4 | FIG. 5 (e) | 16.16 kA | 13.1 kN | 12.2 kN |
| Example 5 | FIG. 5 (f) | 16.30 kA | 12.8 kN | 11.1 kN |

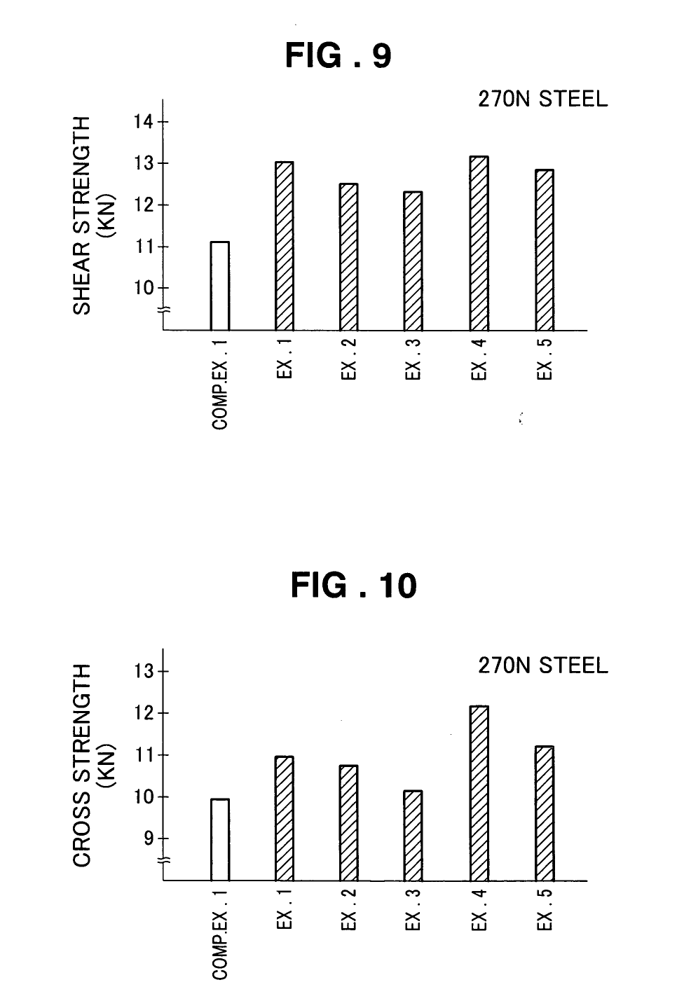

FIG. 9 is a graph comparing Examples 1 to 5 of this invention and Comparative Example 1 in shear strength. Examples 1 to 5 showed an improvement of about 10 to 20% over Comparative Example 1 in shear strength. It was confirmed that the use of the electrodes according to this invention in the spot welding of 270N steel made it possible to form a weld of greatly improved shear strength.

FIG. 10 is a graph comparing Examples 1 to 5 of this invention and Comparative Example 1 in cross strength. Examples 1 to 5 showed an improvement of about 10 to 25% over Comparative Example 1 in cross strength. It was confirmed that the use of the electrodes according to this invention in the spot welding of 270N steel made it possible to form a weld of greatly improved cross strength.

### Comparative Example 2 and Examples 6 to 10

Sheets of 600N steel having a thickness of 1.6 mm were welded by employing a welding pressure of 400 kgf and a welding current as shown in Table 2. Table 2 shows the type of electrodes as employed by selecting from FIG. 5, the welding current and the shear and cross strength as determined from each test specimen.

TABLE 2

| | Type of | Welding | Shear | Cross |
|---|---|---|---|---|
| | electrodes | current | strength | strength |
| Comparative | FIG. 5 (a) | 10.19 kA | 22.5 kN | 14.4 kN |
| Example 2 | | | | |
| Example 6 | FIG. 5 (b) | 12.75 kA | 24.9 kN | 13.5 kN |
| Example 7 | FIG. 5 (c) | 11.86 kA | 24.4 kN | 11.6 kN |
| Example 8 | FIG. 5 (d) | 11.87 kA | 24.6 kN | 13.2 kN |
| Example 9 | FIG. 5 (e) | 13.66 kA | 25.5 kN | 12.6 kN |
| Example 10 | FIG. 5 (f) | 12.95 kA | 24.2 kN | 14.4 kN |

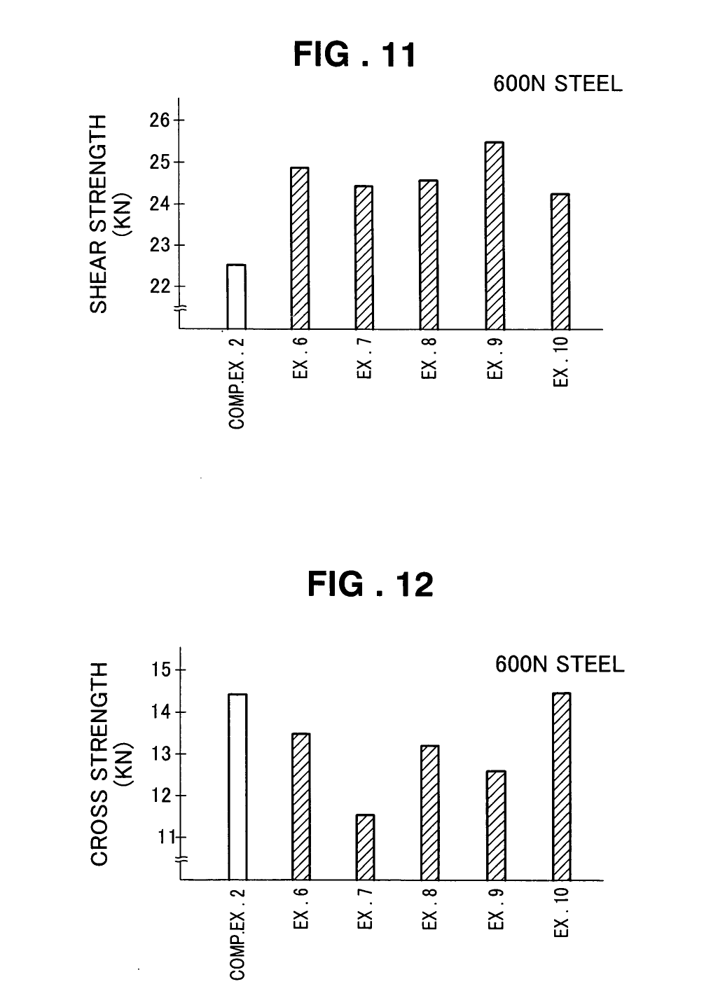

FIG. 11 is a graph comparing Examples 6 to 10 of this invention and Comparative Example 2 in shear strength. Examples 6 to 10 showed an improvement of about 15% over Comparative Example 2 in shear strength. It was confirmed that the use of the electrodes according to this invention in the spot welding of 600N steel made it possible to form a weld of greatly improved shear strength.

FIG. 12 is a graph comparing Examples 6 to 10 of this invention and Comparative Example 2 in cross strength. Examples 6 to 9 were inferior to Comparative Example 2 in cross strength. Example 10 was comparable to Comparative Example 2. It was confirmed that, as 600N steel was considered sensitive to variations in welding conditions, it would be necessary to make further efforts to select or control the type of electrodes, the welding pressure and current appropriately to realize a weld of improved cross strength on 600N steel.

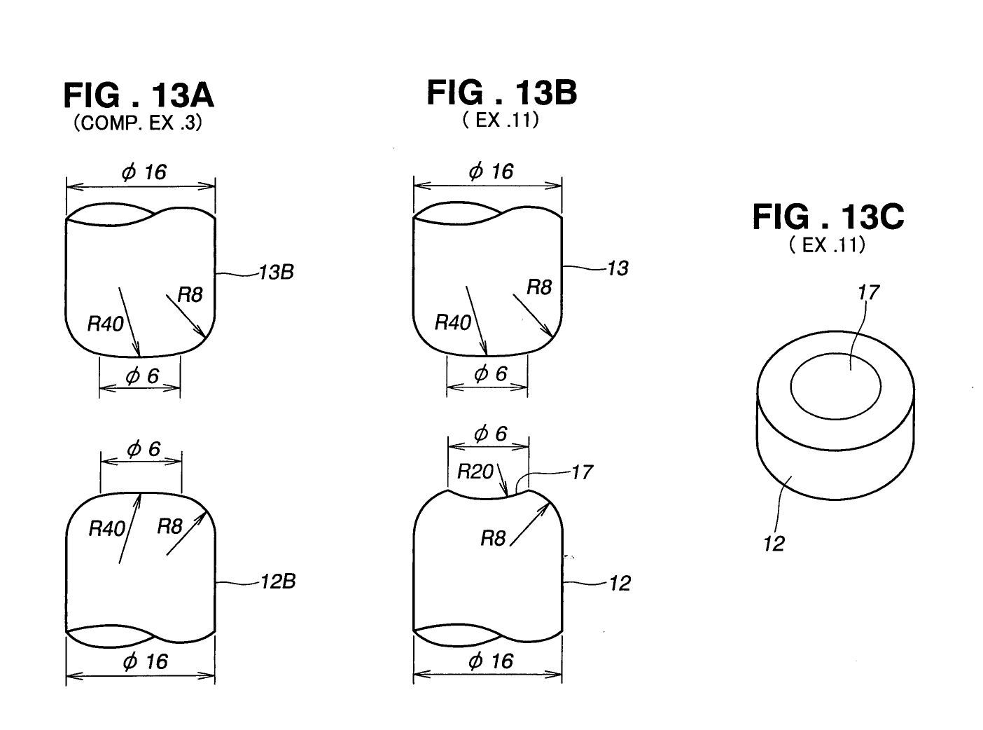

FIG. 13A shows electrodes according to Comparative Example 3 and FIGS. 13B and 13C show electrodes according to Example 11 of this invention.

More specifically, FIG. 13A shows a lower electrode 12B and an upper electrode 13B as prepared for comparative experiments according to Comparative Example 3. The lower and upper electrodes 12B and 13B are of the same shape, each having a diameter of 16 mm, and each electrode has a mildly curved convex end central surface having a diameter of 6 mm and a radius of curvature of 40 mm, and surrounded by a rounded surface having a radius of curvature of 8 mm. Thus, the electrodes 12B and 13B according to Comparative Example 3 are ordinary electrodes known in the art.

FIG. 13B shows a lower electrode 12 and an upper electrode 13 according to Example 11 of this invention. The upper electrode 13 is the same as the upper electrode 13B shown in FIG. 13A. The lower electrode 12 has a diameter of 16 mm and has a concave upper end surface 17 having a diameter of 6 mm and a radius of curvature of 20 mm. FIG. 13C is a perspective view of the lower electrode 12 shown in FIG. 13B and shows the concave surface 17 formed in the center of its upper end.

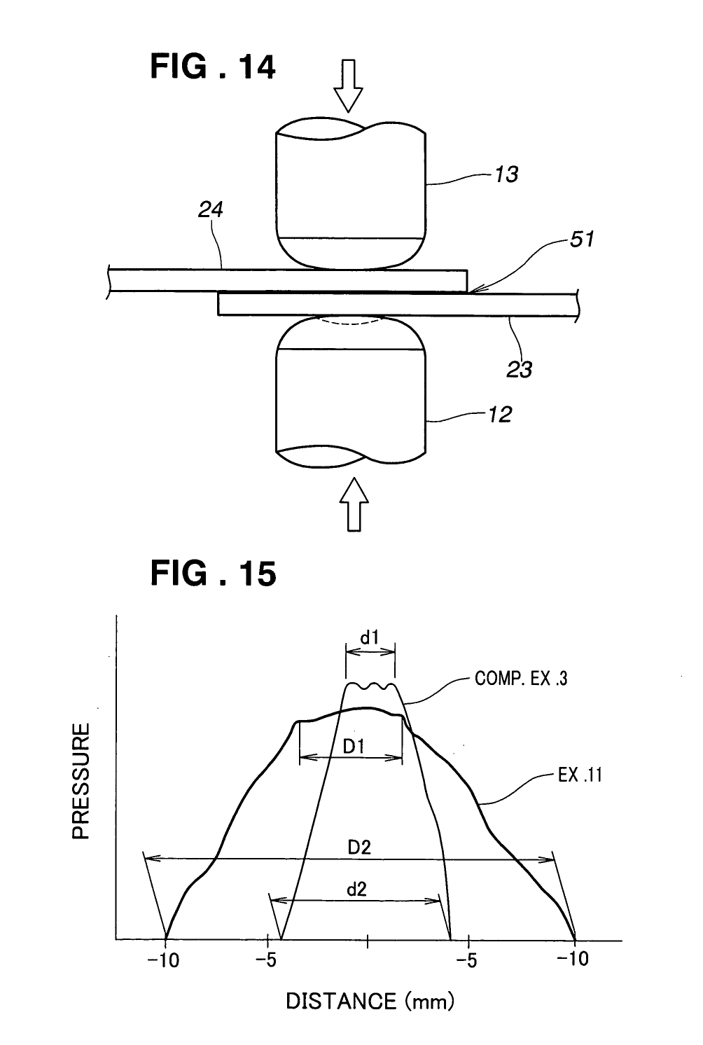

FIG. 14 is a diagram showing the principle of a method of determining the pressure applied by a lower electrode 12 and an upper electrode 13 to a pressure-sensitive film 51 held between two metal sheets 23 and 24. The metal sheets 23 and 24 are both of 600N steel and have a thickness of 1.6 mm. The pressure-sensitive film 51 may be pressure-sensitive paper presenting a different color depending on the pressure applied thereto. Thus, its color makes it possible to determine the amount of pressure as applied.

FIG. 15 is a graph showing the pressure as determined along its vertical axis in relation to the distance from the center of the electrodes as shown along the horizontal axis. The distribution of pressure as applied by the electrodes 12B and 13B shown in FIG. 13A according to Comparative Example 3 was as shown by a curve drawn in a thin line and having a small peak width d1 and a root width d2 of less than 10 mm. It follows that according to Comparative Example 3, no pressure was applied at a distance of 5 mm or more from the center of the electrodes. On the other hand, the distribution of pressure as applied by the electrodes 12 and 13 shown in FIG. 13B according to Example 11 was as shown by a curve drawn in a thick line and having a large peak width D1 and a root width D2 of about 20 mm. It follows that according to Example 11, pressure was effectively applied even at a distance of 10 mm from the center of the electrodes.

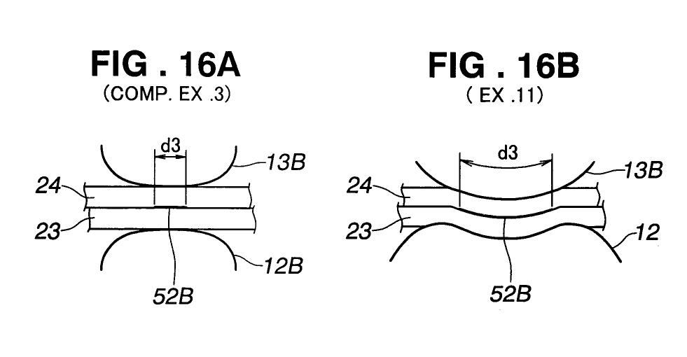

FIGS. 16A and 16B are diagrams prepared from the graph in FIG. 15 and showing the areas of contact made between two metal sheets according to Comparative Example 3 and Example 11, respectively. As is obvious from FIG. 16A, the area 52B of contact according to Comparative Example 3 has a small diameter d3, but as is obvious from FIG. 16B, the area 52 of contact according to Example 11 has a satisfactorily large diameter D3.

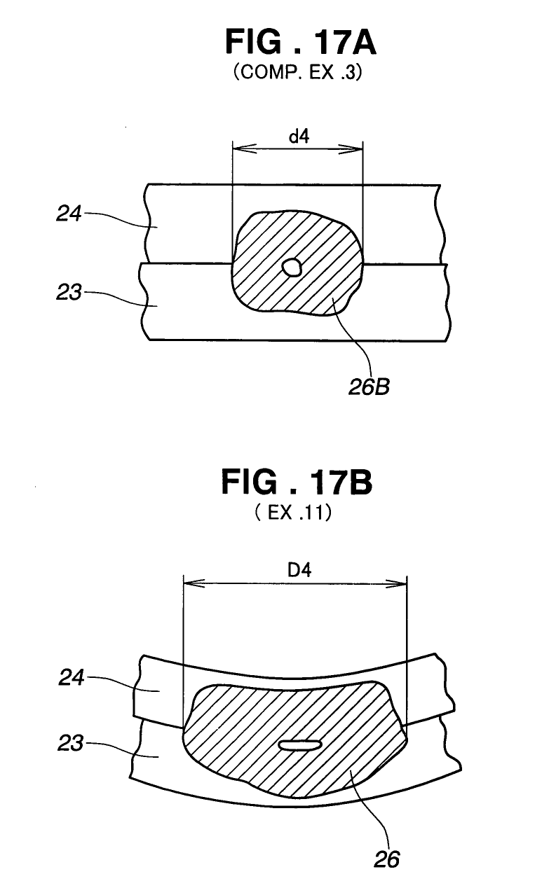

FIGS. 17A and 17B show the weld nuggets formed according to Comparative Example 3 and Example 11, respectively. The weld nuggets were formed by employing the electrodes according to Comparative Example 3 and Example 11, a welding pressure of 1 kN and a welding current 7 kA and were examined in cross section. FIG. 17A shows the cross section of the weld nugget 26B according to Comparative Example 3 as having a dimension d4 of 2.85 mm and FIG. 17B shows the cross section of the weld nugget 26 according to Example 11 as having a dimension D4 of 4.43 mm.

Welding strength can be estimated by the cross-sectional area of the weld nugget 26B or 26 as taken at right angles to the drawing sheet. The cross-sectional area of the weld nugget is regarded as 2.85² in the case of Comparative Example 3, and as 4.43² in the case of Example 11. It, therefore, follows that Example 11 enables 2.4 times as high a welding strength as Comparative Example 3, since the welding strength according to Example 11/that according to Comparative Example 3=4.43²/2.85² =2.4.

Thus, the resistance welding electrodes 12 and 13 according to Example 11 are the resistance welding electrodes used for welding two metal sheets 23 and 24 as the materials to be welded by an electric current supplied to the electrodes when the materials to be welded are held in contact with each other under pressure. The resistance welding electrodes 12 and 13 are characterized in that at least one of them has a concave end surface 17 (see FIG. 13B).

Example 11 could realize an improved welding strength, as stated above. That was apparently due to a large contact area (see 52 in FIG. 16B) suppressing any excessive concentration of an electric current.

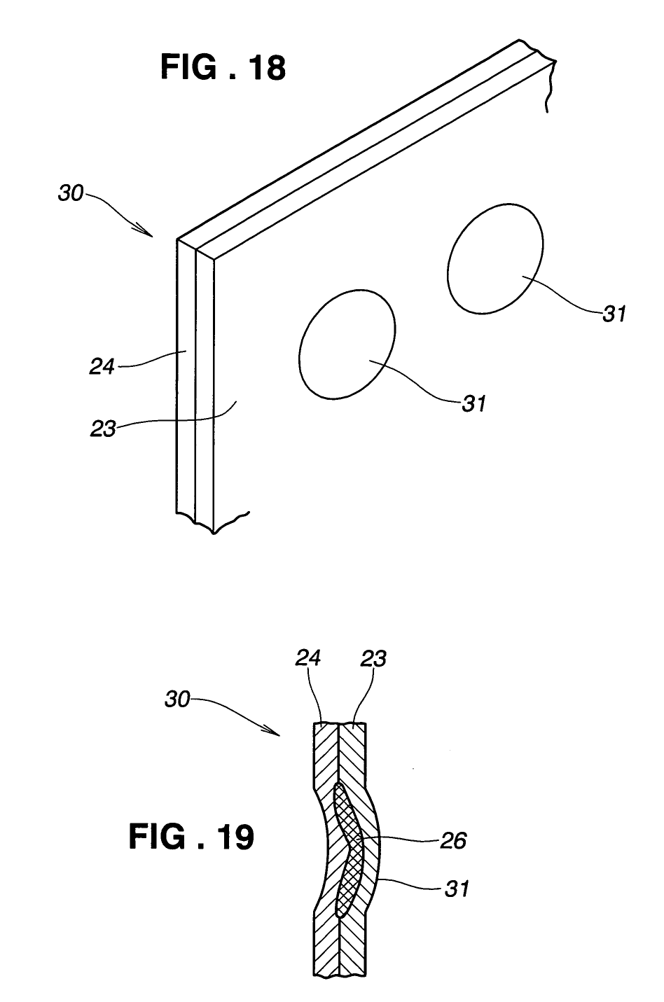

FIG. 18 shows bulged portions 31 protruding from the outer surface of the metal sheet 23 in the welded structure 30. FIG. 19 shows a cross section of the structure as taken across one of the bulged portions 31 shown in FIG. 18. The welded structure 30 comprises materials to be welded prepared by welding the metal sheets 23 and 24, a weld nugget 26, and the bulged portion 31 on the outer surface of one of the materials to be welded. When the bending strength of the two metal sheets 23 and 24 is considered, the presence of any bulged portion 31 spaced apart from the center of their bending increases their cross-sectional factor and secondary moment. According to this invention, the bulged portion 31 formed in a satisfactorily spaced apart relation from the junction between the two metal sheets 23 and 24 adds to the bending strength, tensile strength and rigidity of the welded joint.

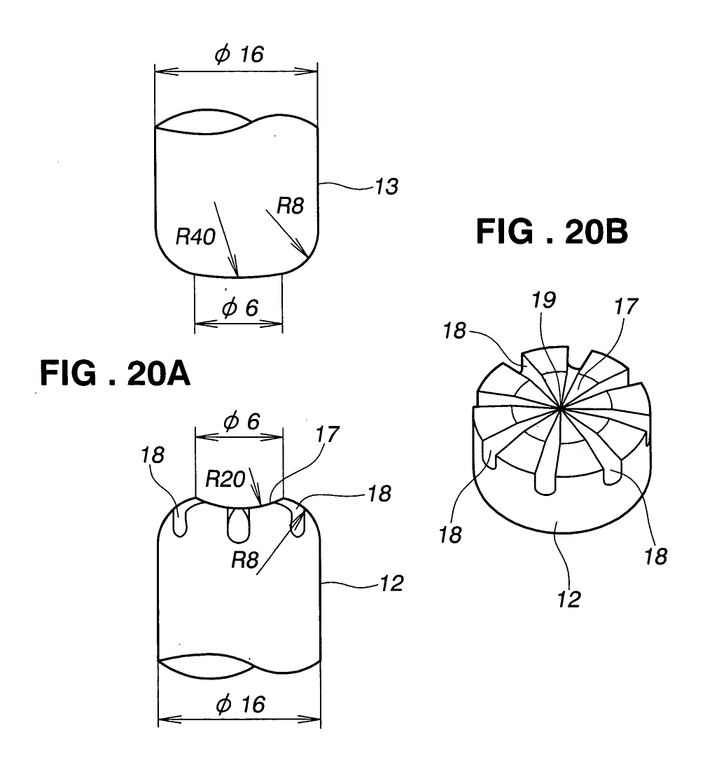

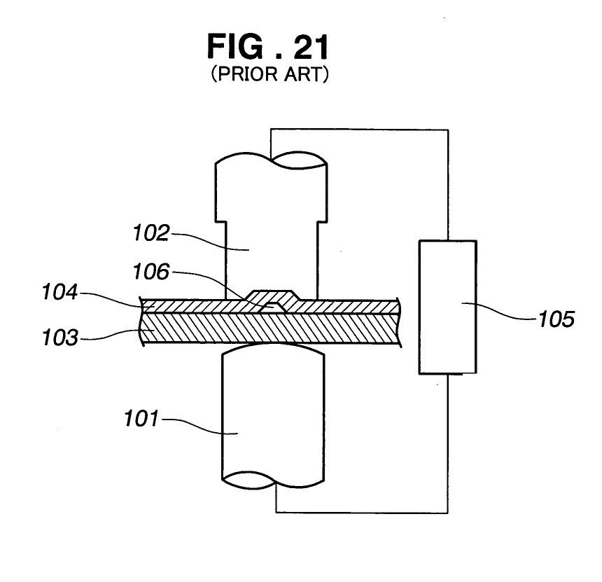

A further example of variation will now be described with reference to FIGS. 20A and 20B. FIG. 20A shows a lower electrode 12 and an upper electrode 13 prepared for experiments according to Example 12. The upper electrode 13 has a diameter of 16 mm, and has a mildly curved convex end central surface having a diameter of 6 mm and a radius of curvature of 40 mm, and surrounded by a rounded surface having a radius of curvature of 8 mm. The lower electrode 12 has a diameter of 16 mm and has a concave upper end surface 17 having a diameter of 6 mm and a radius of curvature of 20 mm, and has a plurality of grooves 18 formed therein. FIG. 20B is a perspective view of the lower electrode 12 showing eight grooves 18 extending radially from the center 19 of the concave upper end surface 17.

A number of expulsion and surface flash experiments were conducted by using the electrodes as described. For comparison, experiments were also conducted by using the electrodes according to Example 11 (see FIG. 13B).

### Experiments 1 and 2

Sheets of 600N steel having a thickness of 1.6 mm were welded by employing a welding pressure as shown in Table 3 and a welding current of 10.5 kA.

TABLE 3

| | Welding conditions | | | | | |
|---|---|---|---|---|---|---|
| | Type of | | Pressure | | | |
| | electrodes | Current | 1 kN | 2 kN | 2.9 kN | 3.9 kN |
| Experiment 1 | | 10.5 kA | X | X | ◯ | ◯ |
| Experiment 2 | | 10.5 kA | X | ◯ | ◯ | ◯ |

X: Expulsion and surface flashes were seen.
◯: No expulsion or surface flash was seen.

Experiment 1 was a welding experiment conducted by employing the electrodes according to Example 11 as shown in FIG. 13B, a current of 10.5 kA and a progressively altered pressure and expulsion and surface flashes were seen when it employed the pressure of 1 or 2 kN. The pressure was apparently too low. No expulsion or surface flash was seen any more when the pressure was raised to 2.9 or 3.9 kN.

Experiment 2 was a welding experiment conducted by employing the electrodes according to Example 12 as shown in FIG. 20A, a current of 10.5 kA and a progressively altered pressure and saw expulsion and surface flashes when it employed the pressure of 1 kN. No expulsion or surface flash was seen any more when the pressure was raised to 2, 2.9 or 3.9 kN. It was apparently owing to the lower electrode having a plurality of groves that the necessary pressure could be lowered from 2.9 kN to 2 kN in Experiment 2, while the lower electrode employed in Experiment 1 did not have any groove.

### Experiments 3 and 4

Sheets of 600N steel having a thickness of 1.6 mm were welded by employing a welding pressure of 3.9 kN and a welding current as shown in Table 4.

TABLE 4

| | Welding conditions | | Welding current | | | |
|---|---|---|---|---|---|---|
| | Type of | | 11 | 11.5 | 12 | 12.5 |
| | electrodes | Pressure | kA | kA | kA | kA |
| Experiment 3 | | 3.9 kN | ◯ | ◯ | X | — |
| Experiment 4 | | 3.9 kN | ◯ | ◯ | ◯ | X |

X: Expulsion and surface flashes were seen.
◯: No expulsion or surface flash was seen.

Experiment 3 was a welding experiment conducted by employing the electrodes according to Example 11 as shown in FIG. 13B, a pressure of 3.9 kN and a progressively altered welding current and expulsion and surface flashes were seen at the current of 12 kA, though not at 11 or 11.5 kA.

Experiment 4 was a welding experiment conducted by employing the electrodes according to Example 12 as shown in FIG. 20A, a pressure of 3.9 kN and a progressively altered welding current and no expulsion or surface flash was seen until it employed the welding current of 12 kA. It was apparently owing to the lower electrode having a plurality of groves that the welding current could be raised from 11.5 kA to 12 kA in Experiment 4, while the lower electrode employed in Experiment 3 did not have any groove.

When a lower welding current is sufficient for welding metal sheets, it is possible to save a larger amount of electrical energy and it is also possible to suppress any thermal strain occurring to a welded joint and thereby minimize any deformation of a welded product. As the required welding pressure is lower, the welding apparatus can be reduced in the size and the weight. A reduction both in welding current and in pressure can be achieved by using an electrode having a concave end surface and grooves formed therein.

Although the welding electrodes and process have been shown and described as applied to the welding of two metal sheets, this invention will, of course, be equally applicable to the welding of three or more sheets.

Obviously, various minor changes and modifications of the present invention are possible in the light of the above teaching. It is therefore to be understood that within the scope of the appended claims the invention may be practiced otherwise than as specifically described.

What is claimed is:

1. A resistance welding electrode combination used for welding together a plurality of metal sheets held on each other under pressure as the materials to be welded, the combination comprising a first electrode and a second electrode, wherein one of the first and second electrodes has a concave end surface having a groove formed therein for distributing a welding current.

2. An electrode combination as set forth in claim 1, wherein the other of the electrodes has a convex end surface.

3. An electrode combination as set forth in claim 1, wherein the groove comprises a radial groove extending through the center of the bottom of the concave end surface.

4. A resistance welding process comprising the steps of:
preparing a pair of electrodes consisting of a first electrode having a concave end surface and a second electrode having a convex end surface, a device for applying pressure to urge one of the electrodes toward the other, a device for supplying a welding current to the electrodes and a plurality of metal sheets laid on each other to form the materials to be welded;
clamping the materials to be welded between the electrodes to cause the materials to undergo plastic deformation; and
supplying a welding current to the electrodes to weld the materials, while maintaining an appropriate pressure between the electrodes.

5. A welding process as set forth in claim 4, wherein the first electrode has a radial groove formed in its concave end surface for distributing the welding current, and welding is conducted while distributing the welding current by the radial grooves formed on the concave surface.

6. A welded structure comprising:
a plurality of metal sheets laid on each other as the materials to be welded;
a weld nugget joining the materials together; and
a bulged portion formed on that portion of the outer surface of one of the materials joined together within which the weld nugget exists.

7. A structure as set forth in claim 6, wherein the bulged portion has a protrusion formed thereon.
